(19) United States
(12) Patent Application Publication
(10) Pub. No.: US 2026/0266719 A1
(43) Pub. Date: Sep. 10, 2026

(54) SYSTEMS AND METHODS FOR DETECTION AND IDENTIFICATION OF SMOKE, DUST AND FOG

(71) Applicant: Torc Robotics, Inc., Blacksburg, VA (US)

(72) Inventors: Margarita Kunjavskaja, Gerlingen (DE); Maximilian Koeper, Ostfidern (DE); Marat Kopytjuk, Heilbronn (DE); Simon Baeuerle, Kassel (DE); Maximilian Yassine Beyen, Leutenbach (DE)

(21) Appl. No.: 19/070,102

(22) Filed: Mar. 4, 2025

(51) Int. Cl. G01N 21/53; B60Q 1/08; G08B 17/107

(52) U.S. Cl. CPC G01N 21/532; B60Q 1/085; G08B 17/107

(57) ABSTRACT

A system for detection of smoke, fog and dust in autonomous vehicles can include one or more detectors mounted to a vehicle to detect an event indicative of at least one of smoke, fog or dust in an environment of the vehicle, and a processing device in communication with the one or more detectors. The processing device can be configured to execute instructions stored in a memory to perform operations comprising receiving, from the one or more detectors, information indicative of the detected event, receiving from one or more cameras of the vehicle one or more images of the environment of the vehicle, classifying, responsive to the detected event, the detected event using the one or more images, and determining, responsive to classifying the detected event, one or more actions to be taken by the vehicle.

### TECHNICAL FIELD

The field of the disclosure relates to detection and classification of smoke, dust and fog. In particular, the field of the disclosure relates to systems and methods for detecting and classifying smoke, dust and fog in autonomous vehicles.

### BACKGROUND

Modern vehicles, and in particular autonomous and semi-autonomous vehicles, include a variety of sensors to perceive their surroundings. The sensors are critical components especially for autonomous and semi-autonomous vehicles, because they act as the “eyes” and “ears” of the corresponding vehicles. In particular, the sensors provide, via respective sensing techniques, various perceptions of the surroundings or environment of the vehicle to enable various driver-assistance features and/or self-driving features. Sensors installed in a modern vehicle constantly monitor a multitude of parameters of the vehicle and its surroundings. Such parameters can include, e.g., engine temperature, oil pressure, tire pressure, vehicle speed, as well as the speed, distance, and relative position of objects around the vehicle. Sensor data collected by the vehicle sensors is typically fed or provided to one or more processing devices or units, such as the electronic control unit (ECU), which can be used to make real-time adjustments or decisions related to various systems of the vehicle.

With advancements in sensing technology and artificial intelligence, modern vehicles are equipped with a wide array of sensors to enable advanced driver-assistance systems (ADASs) and/or automated driving systems (ADSs). These systems rely mainly on sensor data provided by the sensors onboard the vehicle in decision making. As technology continues to evolve and vehicles become more automated, the role of sensors in modern vehicles becomes greater and more critical. In other words, the operation of modern vehicles, and automated vehicles in particular, depends on the reliability and accuracy of the sensors. For example, failure to accurately perceive the surroundings of an autonomous vehicle or failure to point the vehicle in the right direction could result in catastrophic accidents.

Reliable detection and identification of smoke, dust and/or fog is one of the technical challenges faced by ADSs. For example, misperceiving smoke, dust and/or fog as a solid object may cause the autonomous vehicle to stop abruptly. Such decision or action can be dangerous especially on congested highways where the vehicles are travelling at a high rate of speed. Therefore, there is a need to develop systems and methods that enable autonomous vehicles to reliably detect and identify smoke, dust and/or fog when operating.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an example system for detection of smoke, fog and dust is provided. The system can include one or more detectors mounted to a vehicle to detect an event indicative of at least one of smoke, fog or dust in an environment of the vehicle, and a processing device in communication with the one or more detectors. The processing device can be configured to execute instructions stored in a memory to perform operations comprising receiving, from the one or more detectors, information indicative of the detected event, receiving from one or more cameras of the vehicle one or more images of the environment of the vehicle, classifying, responsive to the detected event, the detected event using the one or more images, and determining, responsive to classifying the detected event, one or more actions to be taken by the vehicle.

In some implementations, the one or more detectors can include at least one of at least one of an optical sensor or a laser-based particle counter.

In some implementations, the system can further comprise at least one of a temperature sensor or an air-quality sensor. The at least one temperature sensor or air-quality sensor can be mounted on the vehicle.

In some implementations, the processing device can be configured to classify the detected event further based on one or more measurements from the at least one of the temperature sensor or the air-quality sensor.

In some implementations, the processing device can be configured to classify the detected event using a trained machine learning model. The machine learning model can be configured to receive at least the one or more images of the environment of the vehicle as input and provide a classification of the detected event as output.

In some implementations, the processing device can be configured to transmit, responsive to classifying the detected event as a smoke event, information indicative of the smoke event to a local authority.

In some implementations, the processing device can be configured to determine, responsive to classifying the detected event as a smoke event, a distance between the vehicle and a source of the smoke, and determine whether to change lanes based on the determined distance.

In some implementations, the processing device can be configured to classify the detected event as at least one of a fog event or a dust event, and in response, perform at least one of turning on an infrared camera of the vehicle, turning on a high beam light of the vehicle, or reducing vehicle speed.

In some implementations, the processing device can be configured to trigger cleaning of one or more sensors of the vehicle responsive to at least one of detecting the event or classifying the detected event.

In some implementations, the processing device can be configured, responsive to classifying the detected event, to perform at least one of change a sensor fusion mode of the vehicle or adjust one or more confidence scores for one or more sensors of the vehicle.

In some implementations, the processing device can be configured, responsive to classifying the detected event, to transmit an indication of a classification of the detected event to a remote mission management system, and in response, receive one or more commands from the remote mission management system to be executed by the processing device.

In another aspect, an example method for detection of smoke, fog and dust in vehicle is provided. The method can include detecting, by one or more detectors mounted to a vehicle, an event indicative of at least one of smoke, fog or dust in an environment of the vehicle, receiving, by a computer device of the vehicle from one or more cameras of the vehicle one or more images of the environment of the vehicle, classifying, by a processing device responsive to the detected event, the detected event using the one or more images, and determining, by the processing device, responsive to classifying the detected event, one or more actions to be taken by the vehicle.

In some implementations, the one or more detectors can include at least one of an optical sensor or an ionization sensor.

In some implementations, the method can comprise classifying the detected event further based on one or more measurements from at least one of a temperature sensor or an air-quality sensor of the vehicle. The at least one temperature sensor or air-quality sensor can be mounted on the vehicle.

In some implementations, the method can comprise classifying the detected event using a trained machine learning model. The machine learning model can be configured to receive at least the one or more images of the environment of the vehicle as input and provide a classification of the detected event as output.

In some implementations, the method can be comprise transmitting, responsive to classifying the detected event as a smoke event, information indicative of the smoke event to a local authority.

In some implementations, the method can comprise determining, responsive to classifying the detected event as a smoke event, a distance between the vehicle and a source of the smoke, and determining whether to change lanes based on the determined distance.

In some implementations, the method can comprise classifying the detected event as at least one of a fog event or a dust event, and in response, performing at least one of turning on an infrared camera of the vehicle, turning on a high beam light of the vehicle, or reducing vehicle speed.

In some implementations, the method can comprise triggering cleaning of one or more sensors of the vehicle responsive to at least one of detecting the event or classifying the detected event.

In some implementations, the method can comprise, responsive to classifying the detected event, performing at least one of changing a sensor fusion mode of the vehicle or adjusting one or more confidence scores for one or more sensors of the vehicle.

In some implementations, the method can comprise transmitting, responsive to classifying the detected event, an indication of a classification of the detected event to a remote mission management system, and in response, receiving one or more commands from the remote mission management system to be executed by the processing device of the vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of the autonomous truck and trailer of FIG. 2.

FIG. 4 is a block diagram of the autonomous truck shown in FIGS. 1-3.

FIG. 5 is a block diagram of an example computing system.

FIG. 6 is an image illustrating an example dust event at a road.

FIG. 7 depicts a perception of the dust event of FIG. 6 by an automated driving system (ADS).

FIG. 8 is a flowchart of a method for detection and identification of smoke, dust and fog events, according to an example embodiment of the current disclosure.

FIG. 9 is a flowchart illustrating an implementation of the method of FIG. 8, according to an example embodiment of the current disclosure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Autonomous vehicles rely on respective sensors, such as light detection and ranging (LiDAR) sensors, cameras and radio detection and ranging (radar) sensors, to perceive or understand the respective surrounding or environment. However, certain environmental and/or road conditions make the perception of the vehicle surrounding or environment challenging. In particular, smoke, dust and/or fog significantly impact the perception capabilities of autonomous vehicles. First, the visibility and reliability of LiDAR sensors are significantly hindered by smoke, dust and/or fog. LiDAR sensors in an autonomous vehicle provide the vehicle with detailed three-dimensional (3D) views of the surrounding of the vehicle. However, LiDAR sensors apply light-based detection of the vehicle surrounding and the light beams emitted by the LiDAR sensors get scattered by smoke, dust and/or fog. As such, the LiDAR sensor capability of detecting objects diminishes significantly in these conditions. Furthermore, some of the light scattered by smoke, dust and/or fog may be received by one or more LiDAR sensors leading to false detection. The scattered light landing back at the LiDAR sensor(s) causes the LiDAR sensor(s) to detect the smoke, dust and/or fog as one or more objects. Therefore, data generated by LiDAR sensors in smoke, dust and/or fog conditions is unreliable.

Smoke, dust and/or fog obscure visibility. With regard to images captured by the camera(s), the smoke, dust and/or fog can obscure other vehicles or objects. In particular, images captured by a vehicle driving on a road may show the smoke, dust and/or fog, but may not show other vehicles and/or other objects obscured by the smoke, dust and/or fog. Therefore, images captured in conditions of smoke, dust and/or fog may not provide clear view(s) of the surrounding of the vehicle and do not enable or allow for a clear understanding of the area surrounding the vehicle. However, one advantage of the camera(s) 214 is that smoke, dust and fog can be distinguished from one another in images captured by the camera(s) 214.

Radar sensors 210 are effective in smoke, dust and/or fog conditions, radar sensors, however the output from the radar sensors is typically fused, using sensor fusion techniques, with the outputs from LiDAR and/or cameras in order to precisely perceive, understand and define the vehicle surroundings. For example, if radar sensors are not as reliable as LiDAR sensors and/or cameras in detecting lane lines, road signs and/or traffic signals, the output from the radar sensors may be fused with outputs from LiDAR sensors and/or cameras to produce an accurate understanding of the lane lines, road signs, traffic signals, etc. However, even with enhanced perception achieved by the application of sensor fusion, new methods and systems of sensing and fusing data may need to be applied during smoke, dust and/or fog conditions in order for the output of the sensor fusion process to yield a reliable and accurate perception of the vehicle surroundings. Applying the sensing and fusing systems and methods that are applied when the vehicle is operating in clear conditions when the vehicle is operating in smoke, dust and/or fog will yield inaccurate perceptions of vehicle surroundings. For example, the autonomous vehicle will still misperceive the smoke, dust and/or fog as static object(s).

Embodiments described herein address the above discussed technical problems and provide solutions thereof. In particular, systems and methods described herein address the technical problem of reliable perception of a vehicle surrounding or environment in smoke, dust and/or smoke conditions by using one or more detectors configured to detect events indicative of at least one of smoke, dust or fog. Responsive to the detector(s) being triggered, the autonomous vehicle can initiate a process to use images from vehicle cameras to identify the detected event and take proper actions based on the identification of the detected event. The autonomous vehicle can determine whether the detected event is a smoke event, dust event or fog event. The autonomous vehicle can determine proper actions to be taken based on the event type and execute the actions.

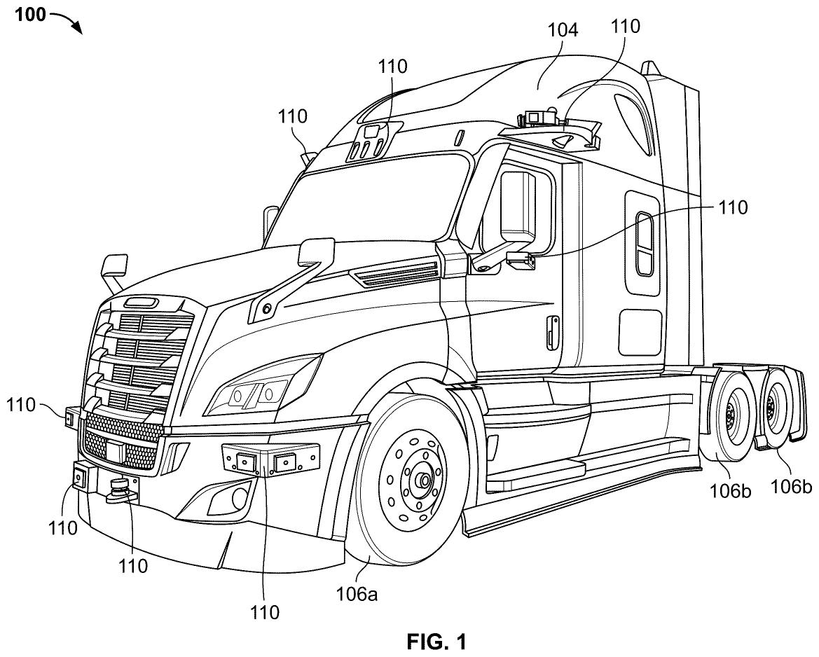

Various embodiments in the present disclosure are described with reference to FIGS. 1-9 below.

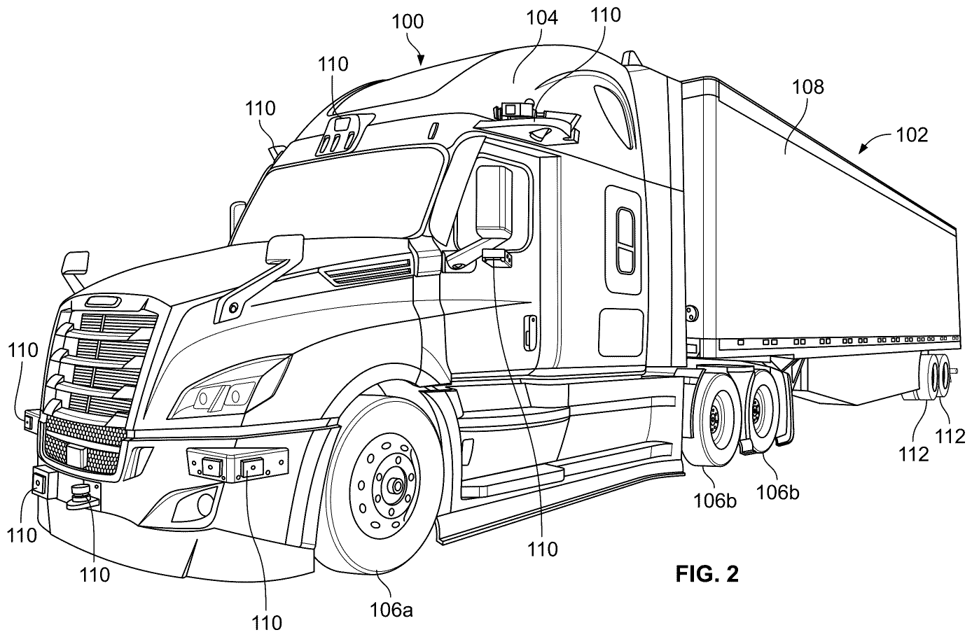

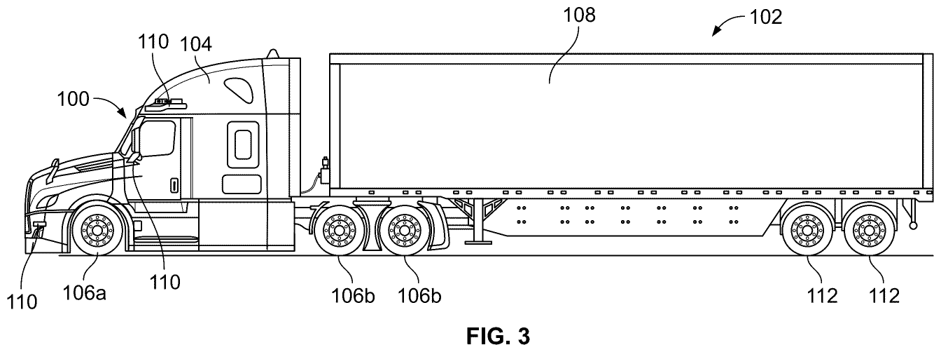

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 may be any vehicle in addition to the specific truck disclosed. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is achieved by the sensors 110. In some embodiments, the vehicle 100 can include, e.g., 5 or more LIDAR sensors, 8 or more cameras, and combinations thereof. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding to the front, rear, sides and corners of the vehicle 100 and the trailer 102 hauled by the vehicle 100.

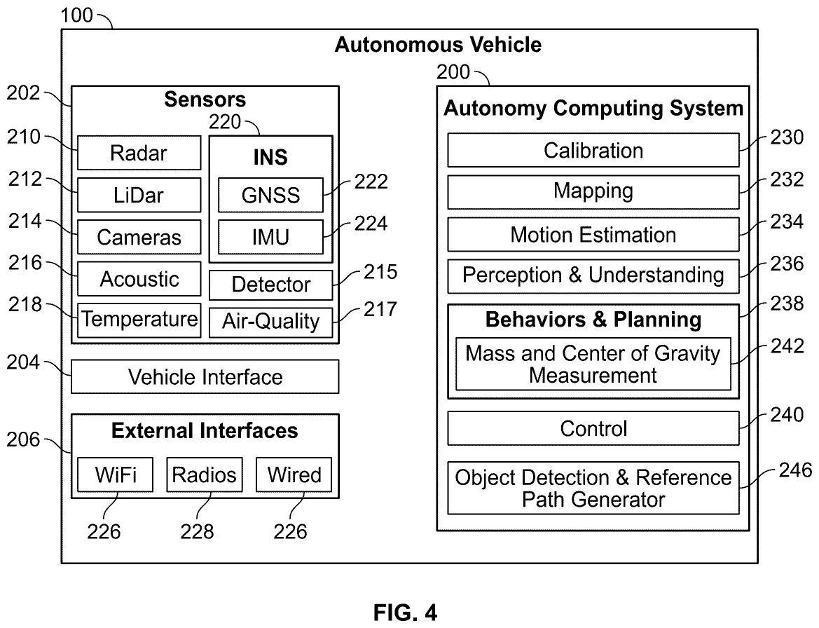

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

The sensors 202 can include one or more detectors 215 for detecting events indicative of at least one of smoke, dust or fog. A detector 215 can be or can include a photoelectric sensor having a light source, e.g., a laser, and a chamber. Ambient air can penetrate into the chamber and the light source can emit a light beam into the chamber. When there is smoke, dust and/or fog in the air, small particles in the air cause the light beam to be scattered and trigger the detector 215. In some implementations, the detector(s) 215 can include other types of sensors, and one such sensor may comprise an ionization sensor.

The sensors 202 can include one or more air-quality sensors 217 to measure the concentration/presence of various particles or pollutants in the surrounding air. An air-quality sensor 217 can be or can include an optical particle counter. The optical particle counter can detect gases like carbon monoxide and carbon dioxide by measuring the absorption of infrared light. The detectors 215 and air-quality sensors 217 are typically mounted to the truck 100 at locations that enable their effective detection and assessment of the quality of the air surrounding the vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

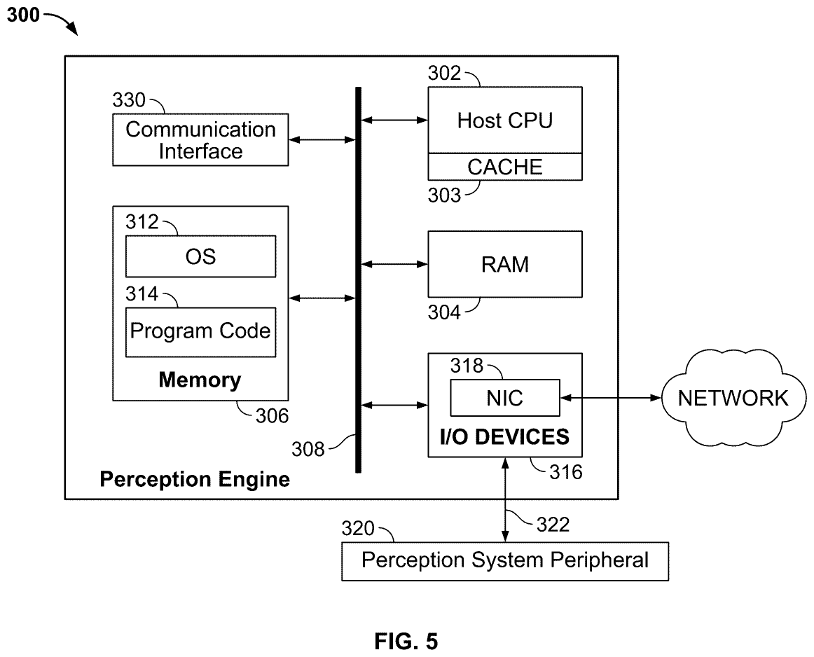

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

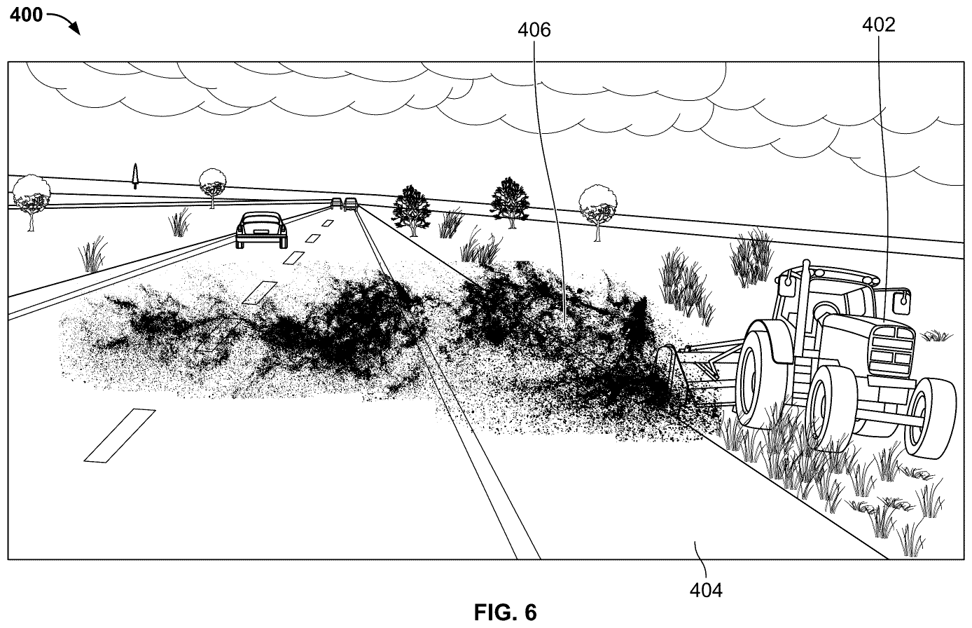

FIG. 6 is an image 400 illustrating an example dust event at a road. A farm tractor 402 on the side of a road 404 causes a dust wave 406 that extends across a portion of the road 404. The dust wave 406 includes a cloud of dust particles moving across the road 406 and reducing visibility. It is to be noted that dust waves can also be caused by a variety of sources such as wind for example. The intensity and severity of dust waves can vary depending on the source of the dust wave, weather conditions and/or availability of loose soil in the area. From the perspective of a vehicle 100 driving on the road 404, the cloud of dust particles typically appears as a wall of dust that can significantly reduce visibility.

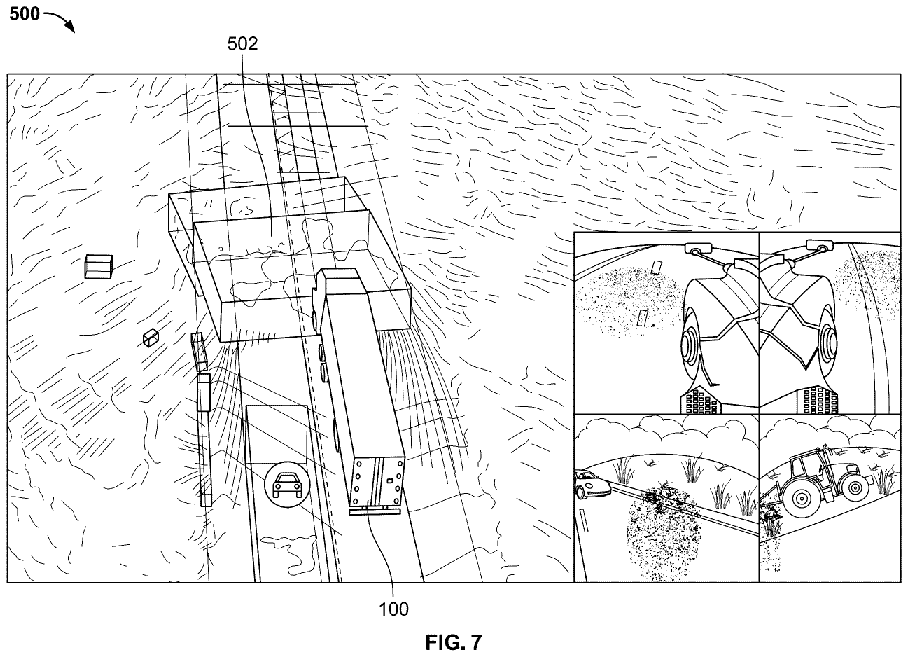

FIG. 7 is an image 500 depicting a perception of the dust event 400 of FIG. 6 by an autonomous vehicle 100. The autonomy computing system 200 or the perception and understanding module 236 can perceive the dust wave 406 or the cloud of dust particles hanging over the road 404 as a stationary object 502. In particular, light beams emitted by LiDAR sensor(s) 212 of vehicle 100 can be scattered by dust particles, and some of the scattered light can return back to the LiDAR sensor(s) 212 resulting in a false detection of stationary object 502 at the location of the cloud of dust particles. The false detection can cause the autonomous vehicle 100 to stop in the middle of the road, which can produce unnecessary traffic congestion on a roadway.

Vision impeding events, similar to event 400 can arise due to smoke or fog. Smoke typically originates from fire and can form a cloud of relatively dark particles. Depending on the intensity and severity of the fire as well as its proximity to a road, the fire can generate or form a cloud of smoke hanging across the road, similar to dust wave 406 which can obscure or significantly reduce visibility along the road that intersects with the smoke or dust wave. Similar to dust particles, smoke particles can also cause light beams emitted by LiDAR sensor(s) 212 to be scattered leading to false detection of a stationary object.

A third vision impeding event, similar to smoke and dust related vision impeding events is an event caused by a wave of fog that can obscure or significantly impede visibility along the road that intersects with the fog wave. Fog is a cloud of vapor that forms near the ground and significantly reduces visibility. Steam, has a similar composition of water vapor entrained in a gas, and its presence along a road, such as emitted from underground through a manhole cover, can create a similar third vision impeding event. Liquid or water droplets in fog or steam can cause light beams emitted by LiDAR sensor(s) 212 to be scattered and cause false detection of stationary object.

The false detection and/or perception of smoke, dust, fog and/or steam as stationary objects presents a serious safety issue and technical challenge for autonomous vehicles 100. Improving the reliability and perception accuracy of the autonomy computing system 200 and/or the perception and understanding module 236 requires reliable detection and identification of smoke events, dust events, fog events and/or steam events. By reliably detecting the vision impeding events and differentiating the vision impeding events from physical objects along the road will enhance the operability of autonomous vehicles such as vehicle 100.

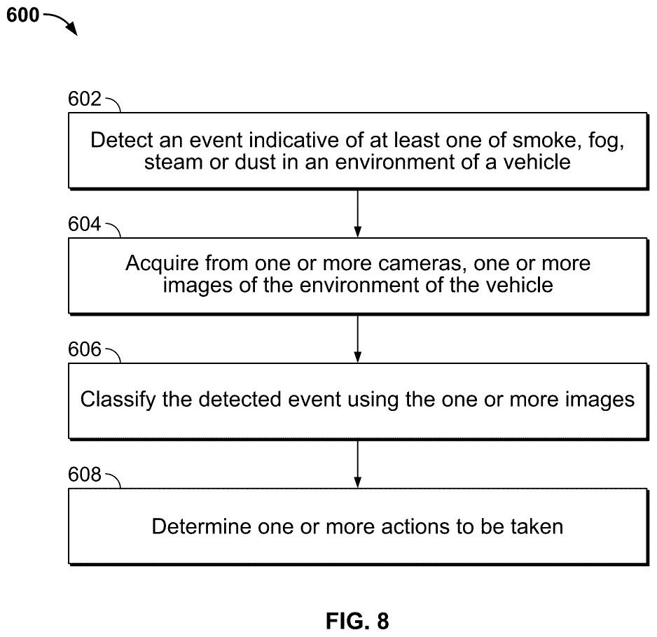

FIG. 8 is a broadly presented flowchart representation of a method 600 for detection and identification of smoke, dust and fog events, according to an example embodiment of the current disclosure. In 602, an event is detected indicative of at least one of smoke, fog, steam or dust in an environment of a vehicle 100. In 604 one or more images of the vehicle environment and surroundings are acquired from one or more vehicle cameras 214 of the vehicle 100. In 606, a detected event is classified using the one or more acquired images. In 608, in response to the event classification, the system determines the appropriate change in vehicle operation required consistent with the detected event classification event. If the event classification is a smoke, dust or fog event, the vehicle operating speed may be reduced or maintained, or if smoke/dust/fog event is sufficiently severe, the vehicle may be stopped. The method 600 can be implemented by the autonomy computing system 200, the perception and understanding module 236 and/or the object detection and reference path generator module 246 of vehicle 100.

The method 600 can include the autonomy computing system 200 detecting an event indicative of at least one of smoke, fog, steam or dust in an environment of a vehicle 100 in 602. The vehicle 100 can include one or more detectors 215 for detecting events indicative of at least one of smoke, dust fog or steam. The detector(s) 215 can be configured to be triggered by smoke, dust fog and/or steam. For example, the detector 215 can be or can include a photoelectric sensor having a light source, e.g., a laser, and a chamber. When smoke, dust, fog and/or steam penetrates into the chamber, respective particles, e.g., dust particles, liquid particles or smoke particles, cause a light beam emitted by the light source to be scattered and trigger the detector 215. When triggered, the detector(s) 215 can send a signal to the autonomy computing system 200 indicative of detection of smoke, fog, steam and/or dust in the environment of the vehicle 100. In some implementations, the signal can be a binary, e.g., with 1 indicating positive detection.

In some implementations, the vehicle 100 can include multiple detectors 215 arranged or mounted at various positions of the vehicle 100. For example, the vehicle 100 can include a first detector 215 mounted at a first side of the vehicle 100 and a second detector 215 mounted at a second side of the vehicle 100 opposite to the first side. Having a plurality of detectors 215 can provide redundancy, e.g., in terms of detection of smoke, dust, fog and/or steam events, and therefore yield greater accuracy and reliability when detecting such events.

The method 600 can include the autonomy computing system 200 acquiring, from one or more cameras 214 of the vehicle 100 one or more images of the environment of the vehicle 100 as indicated in 604. In some implementations, the autonomy computing system 200 can acquire the one or more images from the camera(s) 214, responsive to the triggering of the detector(s) 215 or the reception of the signal(s) indicative of the detected event. The computing system 200 can actuate the camera(s) 214 to capture one or more images or video sequences of the vehicle environment and acquire the captured image(s) or video sequence(s) from the camera(s) 214. In some implementations, the camera(s) 214 can be configured to continuously or periodically capture images or video sequences of the vehicle environment and provide the captured image(s) or video sequence(s) to the autonomy computing system 200 for analysis.

The method 600 can include the autonomy computing system 200 classifying the detected event using the one or more image in 606. While the detector(s) 215 can detect smoke, dust, fog and/or steam events, the detector(s) 215 may not be configured or structured to distinguish between these events. In other words, the detector(s) 215 can be triggered by the presence of smoke, dust, fog and/or steam in ambient air, but cannot determine which of these events is the trigger event. The perception and understanding module 236 can use an object classification model to identify or classify the trigger event. In particular, the perception and understanding module 236 can use an image classification model to determine whether the trigger event is smoke, dust, fog or steam.

Object classification models, and image classification models in particular, are computationally expensive and consume significant computational resources and memory. In the context of autonomous vehicles 100, execution of an object classification model continuously or frequently can increase the discharge rate of the vehicle battery. According to embodiments described herein, the perception and understanding module 236 can execute the object classification model responsive to the detector(s) 215 being triggered. In other words, the autonomy computing system 200 can be configured to execute or perform 606 and 608 of method 600 only responsive to one or more detectors 215 being triggered. As a result, the implementation of the method 600 does not significantly impact the discharge rate of the vehicle battery.

The perception and understanding module 236 can employ an image classification model to determine, using the one or more images, the nature or type of the event detected by the detector(s) 215. The image classification model can include a trained machine learning (ML) model. During a machine learning training phase, a plurality of labeled images, e.g., depicting various scenarios or events of smoke, dust, fog, steam or none of these, can be used to train the ML model. During the deployment phase, the trained ML model can receive the one or more images of the vehicle environment as input and provide a classification or identification of the detected event as output. In some implementations, the trained ML model can output one of the strings “none”, “smoke”, “dust”, “fog” or “steam”. In some implementations, the trained ML model can output one of the numerals from 0 to 5 corresponding to the strings “none”, “smoke”, “dust”, “fog” or “steam”, respectively. The ML model can include a convolutional neural network (CNN), a support vector machine (SVM) classifier, a random forest classifier, a hierarchical classifier or a combination thereof among other types of image classifiers.

In some implementations, the perception and understanding module 236 can classify the detected event further based on one or more measurements from one or more sensors 202 of the vehicle 100. In other words, the perception and understanding module 236 can use the one or more images acquired from the camera(s) 214 as well as one or more measurements from one or more other sensors 202, e.g., other than the camera(s) 214, of the vehicle 100 to precisely identify and/or classify the event detected by the detector(s) 215. For example, the object classification model can receive the one or more images and one or more measurements from air-quality sensor 217 and/or the temperature sensor 218. The air-quality sensor 217 can provide counts of different types of particles in ambient air, which can help identify the type of the detected event. For example, smoke typically includes a relatively high concentration of carbon particles, whereas fog or steam includes a relatively high concentration of water droplets. The ambient temperature can help identify the type of the detected event. For example, a nearby fire that generates smoke is expected to lead to increased ambient temperature. In some implementations, the perception and understanding module 236 can obtain information indicative of weather conditions, e.g., from the Internet or other external source, and feed the weather information as another input to the object classification model. The resulting system classification produced from a review of a variety of sensor data may comprise any of a smoke/dust/fog event or none of these events.

In some implementations, the object classification model can include one or more deep learning models, one or more CNNs or other neural networks, SVMs, random forests, a hierarchical classifier or a combination thereof. In some implementations, the perception and understanding module 236 can apply image preprocessing to the one or more images before feeding corresponding image data to the object classification model as input. For example, the perception and understanding module 236 can extract a plurality of features from the image(s) and provide the extracted features as input to the object classification model.

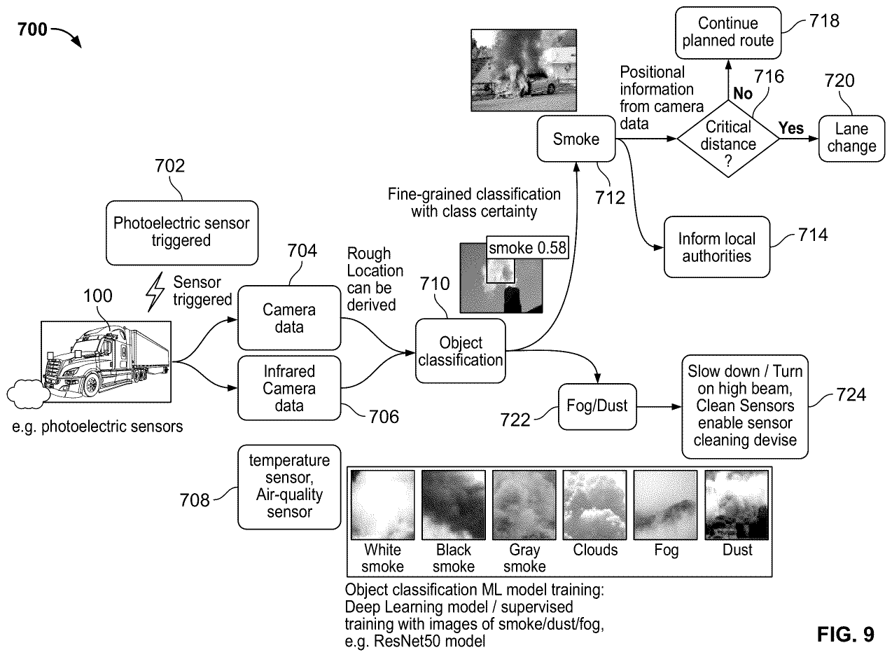

The method 600 can include the autonomy computing system 200 determining one or more proper actions to be taken responsive to the classification of the event in 608. Depending on the type of event detected by the by the detector(s) 215, and air quality sensor 217, the autonomy computing system 200 can take or recommend different actions. Such actions can include changing lanes, reducing vehicle speed, adjusting a sensor fusion process, turning a sensor of a specific type, turning on a specific type of light and/or transmitting a signal to a remote or onboard system among other possible actions. Proper actions taken by the autonomy computing system 200 are described in further detail below in relation to FIG. 9.

FIG. 9 is a flowchart of a process 700 representing an example implementation of the method 600 of FIG. 8, according to an example embodiment of the current disclosure. The process 700 can start with the detector(s) 215, e.g., photoelectric sensor(s), being triggered by a smoke, dust, fog and/or steam event in 702. The detector(s) 215 can send a signal indicative of the triggering event to the autonomy computing system 200. At 704, the camera(s) 214 can capture one or more images of the vehicle environment and provide the captured image(s) to the autonomy computing system 200. In some implementations, the vehicle 100 can include one or more infrared camera(s) and the autonomy computing system 200 can activate the infrared camera(s) responsive to the event detection or the detector(s) 215 being triggered in 706. The infrared camera(s) can provide one or more infrared images of the vehicle environment to the autonomy computing system 200 for use to classify the detected event. In some implementations, the air-quality sensor 217 and/or the temperature sensor 218 can provide respective recorded or measured values to autonomy computing system 200 for use to classify the event in 708.

At 710, the object classification model can identify or classify the type of the event detected by the detector(s) 215 using the image data provided by the camera(s) 214, the infrared image data from the infrared camera(s) and/or the recorded sensor data from the air-quality sensor 217 and/or the temperature sensor 218. The use of the infrared image data from the infrared camera(s) and/or the recorded sensor data from the air-quality sensor 217 and/or the temperature sensor 218 can be optional. In some implementations, the object classification model can be configured to output a classification or certainty score indicative of a probability of successful classification.

In some implementations, upon the object classification model identifies the detected event as smoke in 712, the autonomy computing system 200 can transmit information indicative of the smoke event to a local authority in 714. The smoke event is typically indicative of a fire and the autonomy computing system 200 can send an alert signal indicative of the fire to the local authority, e.g., police department and/or fire department.

In some implementations, the autonomy computing system 200 can determine, e.g., based on the image data from the camera(s) 214 and/or the infrared image data, the location of the source of the smoke or fire. The autonomy computing system 200 can determine or estimate a distance from the source of the smoke or fire. At 716, the autonomy computing system 200 can determine whether the distance between the ego vehicle 100 and the source of the smoke or fire is critical. For example, the autonomy computing system 200 can compare the determined distance to a defined threshold distance, and determine a proper action based on the comparison. For example, upon determining that the source of the smoke or fire is farther than the threshold distance, the autonomy computing system 200 can determine to continue along the planned path, e.g., with no change of lane in 718. The autonomy computing system 200 can determine to change lanes upon determining that the distance to the source of the smoke or fire is critical or too close, e.g., smaller than the threshold distance in 720. In particular, the autonomy computing system 200 can cause the vehicle 100 to change lanes in way to move away from the source of the smoke or fire.

In response to the object classification model identifying or classifying the detected event 702 as a dust event or a fog event in 722, the autonomy computing system 200 can determine one or more acts to be performed in 724. The one or more acts can include at least one of turning on the infrared camera(s) of the vehicle 100 (e.g., if not turned on responsive to the detector(s) 215 being triggered), turning on a high beam light of the vehicle 100, reducing vehicle speed, cleaning one or more sensors 202 or actuating a sensor cleaning device or a sensor cleaning process. For example, the autonomy computing system 200 can actuate the sensor cleaning device, sensor cleaning system or sensor cleaning process to clean the LiDAR sensor(s) 212, the camera(s) 214 and/or the infrared camera(s).

In some implementations, the autonomy computing system 200 can be configured to turn on the infrared camera(s), turn on the high beam light, reduce the vehicle speed, and/or actuate cleaning of one or more sensors, responsive to the detector(s) being triggered. Cleaning the LiDAR sensor(s) 212, camera(s) 214 and/or infrared camera(s) can remove any smoke, dust or vapor that may accumulate on these sensors and degrade sensor data recoded by the sensor(s). Turning on the infrared camera(s) can enhance visibility of the vehicle 100 through smoke, dust, fog and/or steam.

In some implementations, the method 600 can include the autonomy computing system 200 changing a sensor fusion mode of the vehicle 100 and/or adjust one or more confidence scores for one or more sensors 202 of the vehicle 100, responsive to classifying the detected event. For example, the autonomy computing system 200 can support multiple sensor fusion modes and/or sensor fusion processes. Separate sensor fusion modes and/or processes can assign different confidence scores to sensor data from different types of sensors. Each sensor fusion mode or process can be associated with one or more conditions indicating when the sensor fusion mode or process is to be applied. For example, a first sensor fusion mode can be associated with normal conditions, a second sensor fusion mode can be associated with smoke events, a third sensor fusion mode can be associated with dust events and/or a fourth sensor fusion mode can be associated with fog and/or steam events. The autonomy computing system 200 can switch from one sensor fusion mode to another based on the classification or identification of the event detected by the detector(s) 215.

The autonomy computing system 200 can adjust one or more confidence scores for one or more sensors 202 or corresponding sensor data, responsive to classification of the event detected by the detector(s) 215. For example, the autonomy computing system 200 can reduce the confidence score for LiDAR sensor(s) 212 and increase the confidence score for radar sensor(s) 210, responsive to identifying or classifying the detected even as a smoke event. The autonomy computing system 200 can reduce the confidence score for LiDAR sensor(s) 212 and increase the confidence scores for radar sensor(s) 210 responsive to identifying or classifying the detected even as a fog or steam event. The autonomy computing system 200 can reduce the confidence score for LiDAR sensor(s) 212 and camera(s) 214, and increase the confidence scores for radar sensor(s) 210 and/or infrared camera(s), responsive to identifying or classifying the detected even as a dust event. Changing the sensor fusion mode and/or adjusting confidence scores for different types of sensors based on the classification of the detected event enables more accurate and more reliable perception of the surrounding of the vehicle 100.

In some implementations, the method 600 can include the autonomy computing system 200 transmitting, responsive to classifying the detected event, an indication of the classification or identification of the detected event to a remote mission management system, and in response, receiving one or more commands from the remote mission management system to be executed by the autonomy computing system 200. The autonomy computing system 200 can transmit to the remote mission management system information indicative of the type or nature of the detected event, e.g., smoke, dust or fog, a location of the vehicle 100 and/or sensor data from the sensors 202 of the vehicle 100. The remote mission management system can check the information received from the vehicle 100 against other information available from one or more other sources, such as weather forecast data, news associated with the location of the vehicle and/or alerts announced by local authorities. The remote mission management system can transmit data or one or more commands to the autonomy computing system 200. For example, the remote mission management system can transmit a command to change the mission route and a new route to the autonomy computing system 200. The remote mission management system can transmit additional information and a command to repeat the classification of the detected event to the autonomy computing system 200.

In some implementations, the methods described herein can be implemented by a system integrated onboard the vehicle 100. In some implementations, the methods described herein can be implemented by a system remote from the vehicle 100. For example, the system can be implemented in the cloud and can receive sensor measurements from vehicle sensors 202 via a telecommunication network.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for vehicle detection of smoke, fog and dust, the system comprising:
one or more detectors mounted to a vehicle to detect an event indicative of at least one of smoke, fog or dust in an environment of the vehicle; and
a processing device in communication with the one or more detectors, the processing device is configured to execute instructions stored in a memory to perform operations comprising:
receive, from the one or more detectors, information indicative of the detected event;
cause one or more cameras of the vehicle to capture one or more images of the environment of the vehicle;
classify, responsive to the detected event, the detected event using the one or more images; and
determine, responsive to classifying the detected event, one or more actions to be taken by the vehicle.

2. The system of claim 1, wherein the one or more detectors include at least one of:
an optical sensor; or
an ionization sensor.

3. The system of claim 1, wherein the system further comprises at least one of:
a temperature sensor; or
an air-quality sensor, wherein the at least one temperature sensor or air-quality sensor is mounted on the vehicle.

4. The system of claim 3, wherein the processing device is configured to:
classify the detected event further based on one or more measurements from the at least one of the temperature sensor or the air-quality sensor.

5. The system of claim 1, wherein the processing device is configured to classify the detected event using a trained machine learning model, the machine learning model configured to receive at least the one or more images of the environment of the vehicle as input and provide a classification of the detected event as output.

6. The system of claim 1, wherein the processing device is configured to:
transmit, responsive to classifying the detected event as a smoke event, information indicative of the smoke event to a local authority.

7. The system of claim 1, wherein the processing device is configured to:
determine, responsive to classifying the detected event as a smoke event, a distance between the vehicle and a source of the smoke; and
determine whether to change lanes based on the determined distance.

8. The system of claim 1, the processing device is configured to:
classify the detected event as at least one of a fog event or a dust event; and
in response, perform at least one of:
turn on an infrared camera of the vehicle;
turn on a high beam light of the vehicle; or
reduce vehicle speed.

9. The system of claim 1, wherein the processing device is configured to trigger cleaning of one or more sensors of the vehicle responsive to at least one of detecting the event or classifying the detected event.

10. The system of claim 1, wherein the processing device is configured to:
responsive to classifying the detected event, perform at least one of:
change a sensor fusion mode of the vehicle; or
adjust one or more confidence scores for one or more sensors of the vehicle.

11. The system of claim 1, wherein the processing device is configured to:
transmit an indication of a classification of the detected event to a remote mission management system; and
in response, receive one or more commands from the remote mission management system to be executed by the processing device.

12. A method for vehicle detection of smoke, fog and dust, the method comprising:
detecting, by one or more detectors mounted to a vehicle, an event indicative of at least one of smoke, fog or dust in an environment of the vehicle;
capturing, by one or more cameras of the vehicle, one or more images of the environment of the vehicle;
classifying, by a processing device responsive to the detected event, the detected event using the one or more images; and
determining, by the processing device, responsive to classifying the detected event, one or more actions to be taken by the vehicle.

13. The method of claim 12, wherein the one or more detectors include at least one of:
an optical sensor; or
an ionization sensor.

14. The method of claim 12, comprising:
classifying the detected event further based on one or more measurements from at least one of a temperature sensor or an air-quality sensor of the vehicle.

15. The method of claim 12, comprising:
classifying the detected event using a trained machine learning model, the machine learning model configured to receive at least the one or more images of the environment of the vehicle as input and provide a classification of the detected event as output.

16. The method of claim 12, comprising at least one of:
transmitting, responsive to classifying the detected event as a smoke event, information indicative of the smoke event to a local authority; or
triggering cleaning of one or more sensors of the vehicle responsive to at least one of detecting the event or classifying the detected event.

17. The method of claim 12, comprising:
determining, responsive to classifying the detected event as a smoke event, a distance between the vehicle and a source of the smoke; and
determining whether to change lanes based on the determined distance.

18. The method of claim 12, comprising:
classifying the detected event as at least one of a fog event or a dust event; and
in response, performing at least one of:
turning on an infrared camera of the vehicle;
turning on a high beam light of the vehicle; or
reducing vehicle speed.

19. The method of claim 12, comprising:
responsive to classifying the detected event, performing at least one of:
changing a sensor fusion mode of the vehicle; or
adjusting one or more confidence scores for one or more sensors of the vehicle.

20. The method of claim 12, comprising:
transmitting an indication of a classification of the detected event to a remote mission management system; and
in response, receiving one or more commands from the remote mission management system to be executed by the processing device.
